(19) United States
(12) Patent Application Publication
(10) Pub. No.: US 2006/0124391 A1
(43) Pub. Date: Jun. 15, 2006

(54) Safety line traveller and support

(76) Inventors: Karl Jones, Devizes (GB); Peter Robert Flux, Devizes (GB)

Correspondence Address: BROOKS KUSHMAN P.C., 1000 TOWN CENTER, TWENTY-SECOND FLOOR, SOUTHFIELD, MI, 48075, US

(21) Appl. No.: 10/537,424

(22) PCT Filed: Dec. 5, 2003
(86) PCT No.: PCT/GB03/05313

§ 371 Date: Oct. 11, 2005

(30) Foreign Application Priority Data
Dec. 6, 2002 (GB) 0228524.5

(51) Int. Cl. A62B 37/00

(52) U.S. Cl. 182/36

(57) ABSTRACT

A traveller for a fall arrest system comprises a body having a passage therethrough, a slot narrower than the passage linking the passage to the exterior of the body, and a load member suitable to attach the traveller to fall safety equipment. The slot is formed between an inner gate extending outwardly relative to the passage and an outer gate extending inwardly relative to the passage, the inner gate and outer gate having respective opposed convex surfaces defining the slot between them. The traveller is arranged such that when the traveller is mounted on a support the inner gate and outer gate lie on a common radius of respective concentric circles about the support.

This invention relates to a traveller and support for a safety line. The traveller can be used to secure fall safety equipment to a safety line which is supported by the supports and the traveller and supports cooperate to allow the traveller to move along the safety line and traverse the supports without the traveller being detached from the safety line.

In order to protect personnel from falls when working at height it is usual, and often a legal requirement, to provide an elongate safety line or track running across or along the area in which the personnel are to work and to attach the personnel to the elongate safety line using a traveller able to slide along the line and connected to a safety harness worn by the personnel through a flexible lanyard.

The flexible lanyard allows the user freedom of movement to either side of the safety line and the traveller is pulled along the safety line by the lanyard to follow the user as they move along the safety line.

The safety line is anchored at each end. Further, in order to allow a long uninterrupted safety line and to allow the safety line to be guided around corners it is usually necessary for the safety line to also be mounted on a number of intermediate supports disposed along its length. Accordingly, the traveller and supports are arranged to cooperate so that the traveller can automatically pass along the safety line over the intermediate supports when pulled by the user with the lanyard without it being necessary to detach the traveller from the safety line.

A number of systems have been proposed in which this is carried out by the intermediate support including an arm section narrower than the safety line and the traveller being formed in a substantially C-shape broken by a slot, the slot being narrower than the safety line but wider than the arm of the intermediate support so that arm can pass through the slot to allow the traveller to traverse the intermediate support when pulled along the safety line but not allowing the traveller to become detached from the safety line.

A problem which has been encountered in systems of this type is ensuring that the slot in the traveller is properly aligned with the arm of the intermediate support in order to allow passage of the traveller over the intermediate support.

It has been proposed to overcome this problem in the past by using two parallel safety lines or a track having a non-circular cross-section so that a traveller engaged with both parallel safety lines or with the track respectively has its orientation controlled so that the slot and support are in alignment. However, such an approach cannot be used in a traveller for use with a single safety line because a safety line has a substantially circular cross-section and so cannot be used to control the orientation of a traveller sliding along it.

It has also been proposed to control the alignment of a traveller on a single safety line so that the slot aligns with the safety line arm by using the load applied to the traveller by the safety lanyard to control the orientation of the traveller.

The problem with systems of this type is that in order for the traveller to be correctly rotationally aligned on the safety line so that the slot is aligned with the intermediate support arm the load applied by the safety lanyard to the traveller must be maintained within a small specified range of directions.

For example, where the safety line passes over the area in which users are to work above their head height the traveller and intermediate supports can be arranged so that the slot in the traveller is aligned with the intermediate support arm when the load applied to the traveller through the safety lanyard is vertically below, or in a small arc centered on the vertical below, the safety line. However, such a system suffers from the problem that it will not work if the user moves out of a narrow strip centred below the safety line because this will result in off vertical loads being applied through the lanyard as the user moves further away from the safety line. This will cause the traveller to rotate until the traveller slot and intermediate support arm no longer align. Accordingly, systems of this type are only suitable for use in situations where personnel movement is constrained to a narrow strip below the safety line, such as movement along catwalks, but are not suitable for situations where personnel can move freely about a large area.

The dependence of the known fall arrest systems discussed above on direct rotational alignment of the traveller about the safety line is that even where the movement of personnel using the system is constrained to a narrow region which will generally maintain the orientation of the traveller in the desired position, temporary rotational deflection and oscillation of the traveller around the safety line caused by the varying load applied along the safety line guard as the user moves can still commonly cause the traveller to be misaligned on contact with the support so that the traveller stops abruptly. In many situations, in addition to stopping abruptly on contact there is also a risk that the traveller will become locked in place against the support so that the user must jerk or shake the safety line to unlock the traveller from the support and move it to traverse the support. Such sudden stopping and locking up of travellers is a safety hazard in its own rights because of the risk of users falling or dropping equipment when the locking of the traveller safety support suddenly checks their movement it is also a safety risk because many users will in practice react to a safety harness system which regularly locks in this way by simply disconnecting themselves from the system and working about it, resulting in unnecessary fall injuries and deaths.

The final problem with the known fall arrest systems is that they generally rely upon relatively moving parts on the traveller and support having narrow clearances. It has been found in practice that such narrow clearances are prone to becoming clogged by debris resulting in the traveller failing to smoothly traverse the supports as it moves along the safety line. This problem is usually relatively minor in normal outdoor environments, but can be a problem in dirty and dusty industrial environments.

The present invention is intended to overcome these problems at least in part.

In a first aspect, this invention provides a traveller for a fall arrest system comprising a body having a passage therethrough, a slot narrower than the passage linking the passage to the exterior of the body, and a load member suitable to attach the traveller to fall safety equipment, the slot being formed between an inner gate extending outwardly relative to the passage and an outer gate extending inwardly relative to the passage, the inner gate and outer gate having respective opposed convex surfaces defining the slot between them, the traveller being arranged such that when the traveller is mounted on a support the inner gate and outer gate lie on a common radius of respective concentric circles about the support.

In a second aspect this invention provides a support for a safety line in a fall arrest system comprising a support section suitable for retaining a safety line and attachment means for attaching the support to a structure, the supporting section and the attachment means being connected by an arm, the arm having a tangential section narrower than the safety line and extending substantially tangentially relative to a safety line retained in the supporting section.

In a third aspect this invention provides a fall arrest system comprising a safety line, at least one support and a traveller, in which the support comprises a support section retaining the safety line and an attachment means for attaching the support to a structure, the support section and attachment means being connected by an arm having a tangential section narrower than the safety line and extending substantially tangentially relative to the safety line, and the traveller comprising a body having a passage therethrough, a slot narrower than the safety line linking the passage to the exterior of the body and a load member suitable to attach the traveller to fall safety equipment, the slot being formed between an inner gate and an outer gate having respective opposed surfaces defining the slot between them, the inner gate and outer gate being arranged such that when the traveller is mounted on the support within the passage the tangential section of the arm can pass through the slot.

Preferred embodiments of the invention will now be described by way of example only with reference to the accompanying diagrammatic Figures, in which:

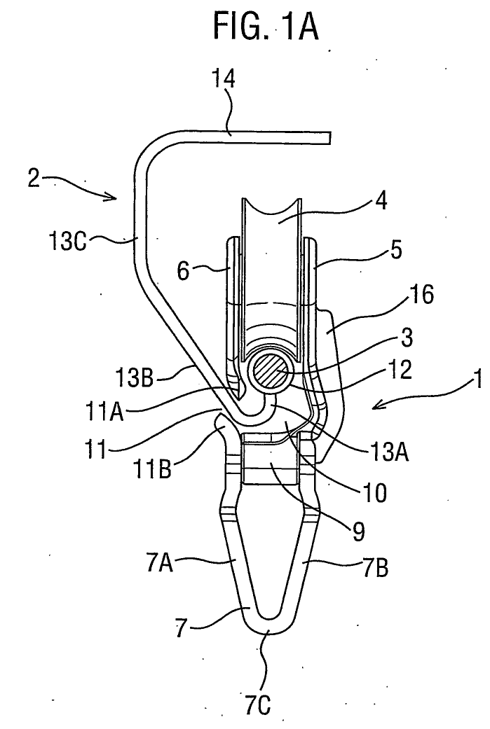

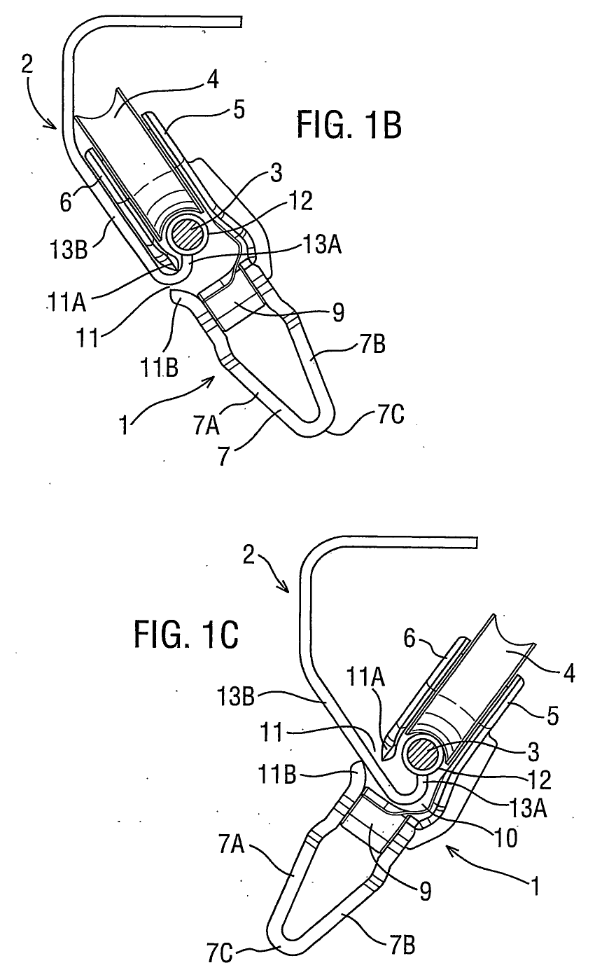

FIG. 1A shows an end view of a traveller and support according to a first embodiment of the invention with the traveller at the centre of its range of movement;

FIG. 1B shows a traveller and support of FIG. 1A a first extreme of the range of movement;

FIG. 1C shows the traveller and support of FIG. 1A at a second extreme of the range of movement;

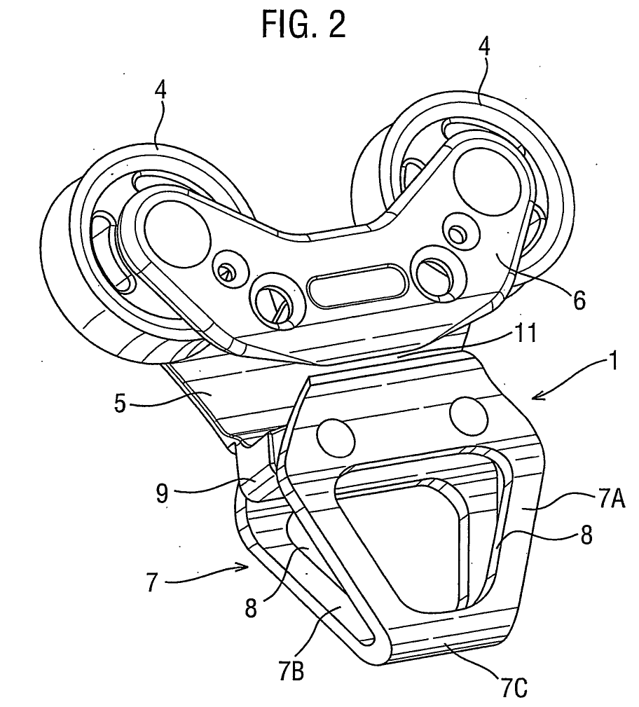

FIG. 2 shows a perspective view of the traveller of FIG. 1A;

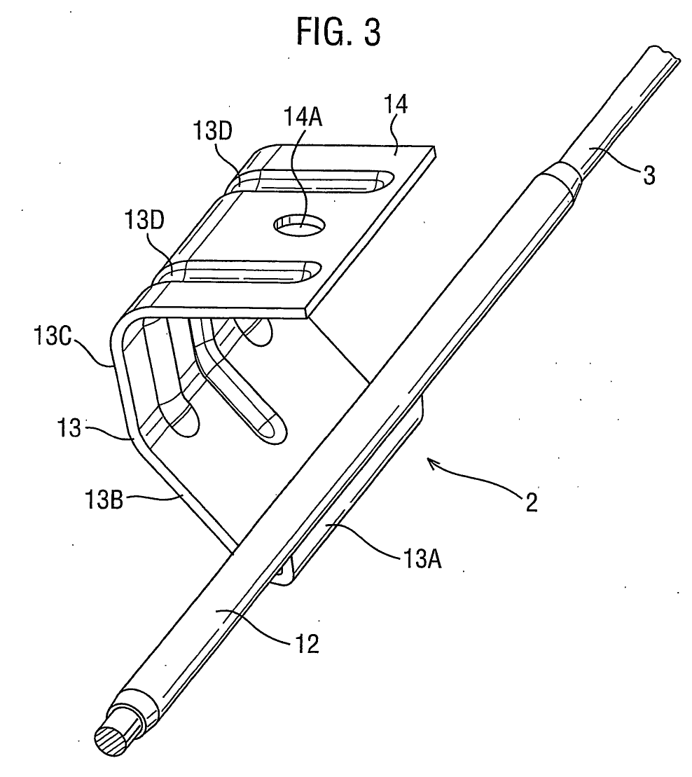

FIG. 3 shows a perspective view of a support of FIG. 1A;

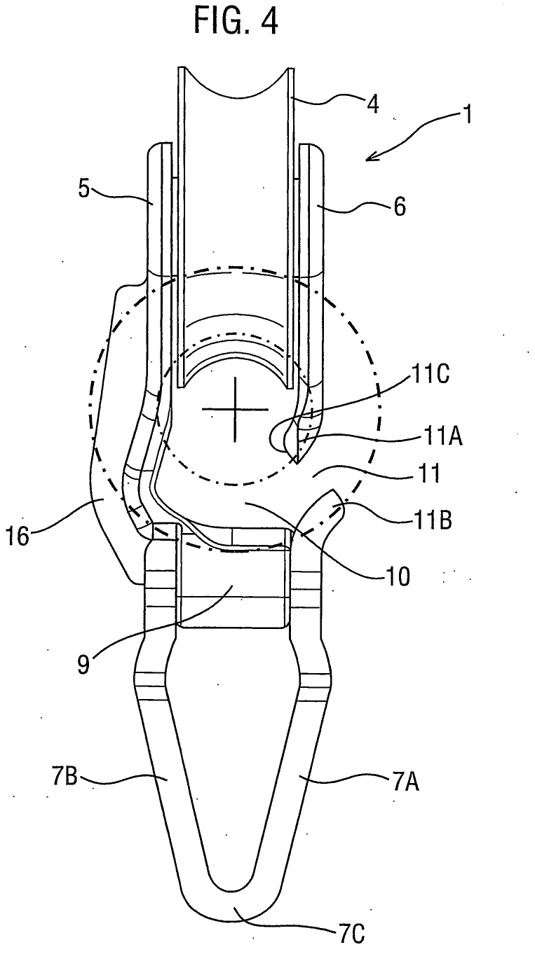

FIG. 4 shows an explanatory diagram showing geometric features of the traveller;

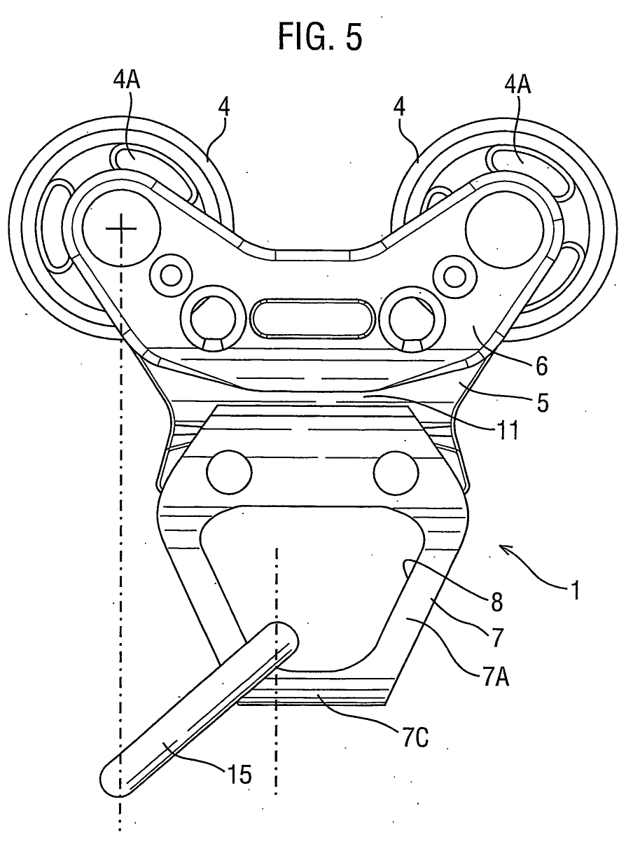

FIG. 5 is a side view of the traveller of FIG. 1A with a lanyard attached;

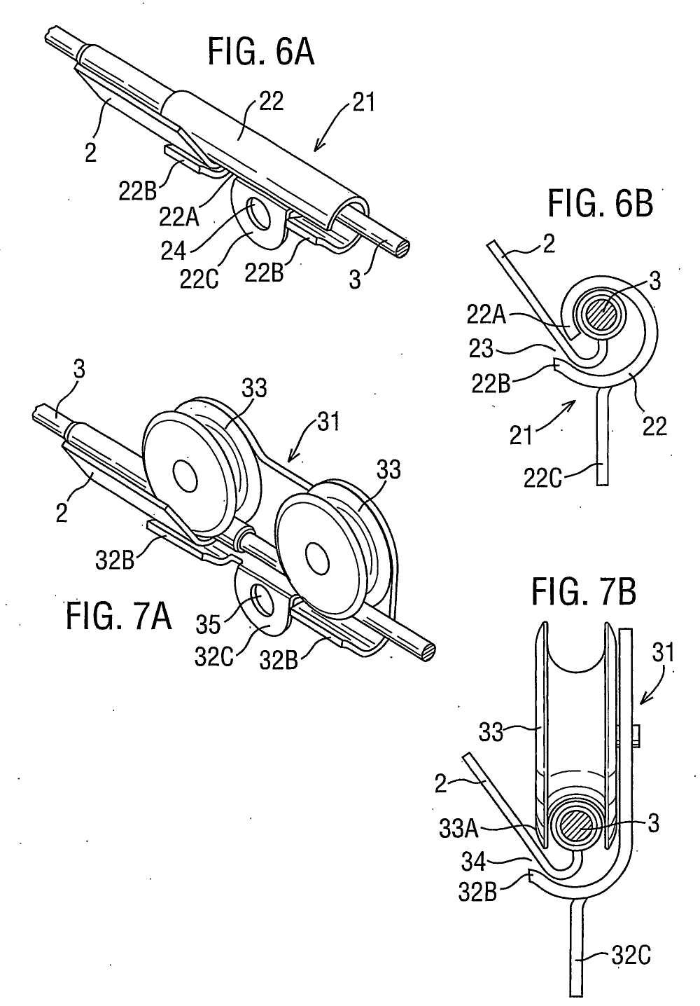

FIG. 6A is a perspective view of traveller and support according to a second embodiment of the invention;

FIG. 6B shows an end view of the traveller and support of FIG. 6A;

FIG. 7A shows a perspective view of a traveller and support according to a third embodiment of the invention;

FIG. 7B shows an end view of the traveller and support of FIG. 7A;

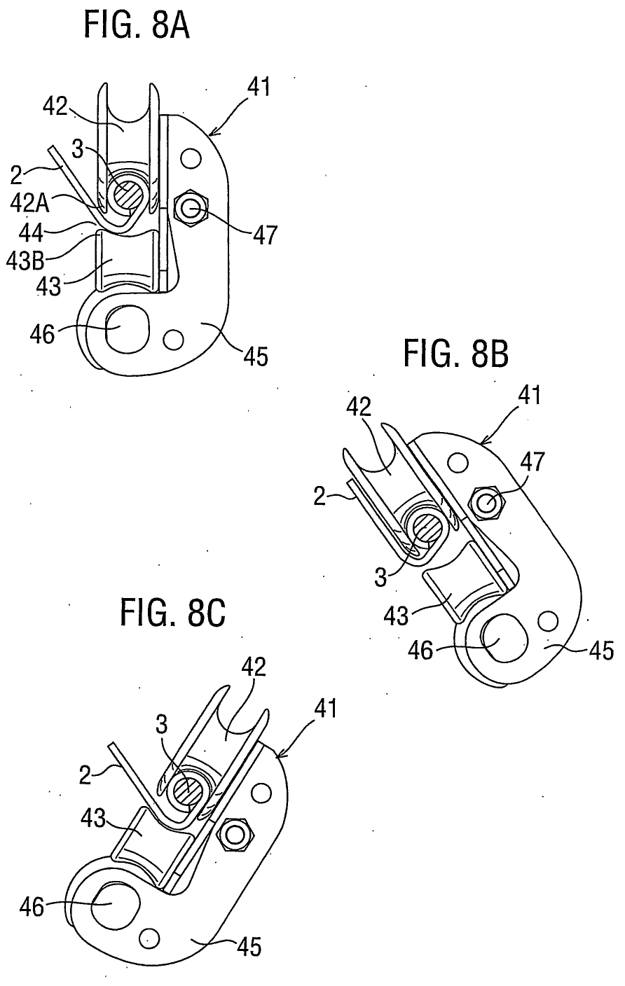

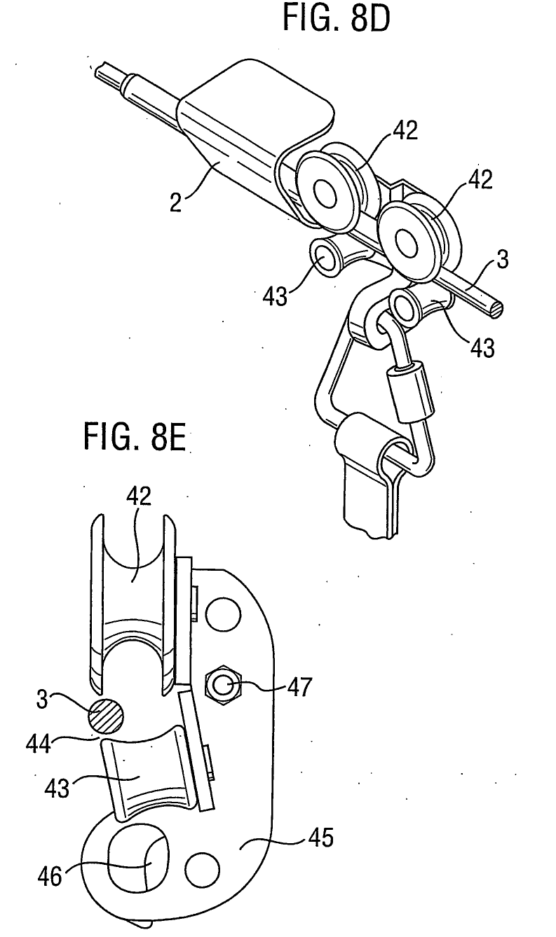

FIG. 8A shows an end view of a traveller and support according to a fourth embodiment of the invention with the traveller at the centre of its range of movement;

FIG. 8B shows the traveller and support of FIG. 8A at a first extreme of the range of movement;

FIG. 8C shows the traveller and support of FIG. 8A at the second extreme of the range of movement;

FIG. 8D shows a perspective view of the traveller and support of FIG. 8A with a lanyard attached; and,

FIG. 8E shows an end view of the traveller of FIG. 1A opened out to release the safety line.

FIGS. 1A to 1C show end views of a safety line traveller 1 according to the first embodiment of the invention when passing over a cooperating support 2 also according to the invention. In FIG. 1A the traveller 1 is shown suspended from the support 2 in a substantially vertical orientation and FIGS. 1B and 1C respectively show the traveller passing and suspended from the support 2 at the extremes of the possible range of relative orientations to the right in FIG. 1B and to the left in FIG. 1C.

Perspective views of the traveller 1 and the support bracket 2 are shown in FIGS. 2 and 3 respectively.

The safety line traveller 1 moves along a safety line 3 which is supported at intervals by supports 2.

The traveller 1 includes a pair of wheels 4 mounted in line in a tandem arrangement and supported for rotation relative to a pair of spaced apart side plates 5 and 6. An attachment element 7 extends from the side plates 5 and 6 and defines a pair of apertures 8. The attachment element 7 and apertures 8 allow a safety lanyard to be attached to the traveller by passing a carabineer or similar attachment device through the apertures 8. The side plates 5 and 6 are interconnected by a fixing element 9 and the attachment section 7 is formed by two substantially flat attachment elements 7A and 7B connected together at a first end by the fixing section 9 and in contact and fixed together at a second end 7C remote from the fixing section 9. The apertures 8 are formed in the attachment elements 7A and 7B between the second end 7C and the fixing section 9.

Preferably, the two attachment elements 7A and 7B are integrally formed from a single piece of material.

The wheels 4, the side plates 5 and 6 and the fixing section 9 define a passage 10 between them. The side plate 6 is broken by a slot 11 extending along the full length of the second side plate 6. The slot 11 is narrower than the diameter of the safety line 3 with which the traveller 1 is intended to be used. Further details of the geometry of the slot will be discussed below.

In use as part of a fall arrest or height safety system the traveller 1 is suspended from the safety line 3 with the wheels 4 above and in contact with the safety line 3 and the attachment section 7 hanging below the safety line 3. A safety lanyard connected to fall safety equipment worn by a user, for example a harness, is connected to the attachment section 7, generally through a carabineer. This configuration allows the traveller 1 to move smoothly along the safety line 3 to follow the user connected to the traveller 1, under the control of forces transmitted through the safety lanyard attached to the attachment section 7.

The support 2 comprises a cylindrical tubular safety line locating section 12 connected through an arm 13 to an connection element 14 which connects the support 2 to some fixed structure (not shown).

In the illustrated embodiment the connection section 14 is shown as a flat pad having a bolt hole 14A. This is an illustrative example and it will be understood that any other desired connection arrangement can be used.

The safety line 3 passes through the cylindrical tube 12 in order to retain the safety line 3 in place relative to the support structure.

The arm 13 has three sections, a first radial section 13A extending vertically downwards from the tube 12, a second section 13B extending from the lower end of the first section 13A substantially tangentially to the centre of rotation of the cylindrical tube 12, and a third section 13C connecting the tangential second section 13B to the connection section 14.

The thickness of the tangential second section 13B of the arm 13 is less than the width of the slot 11 in the traveller 1 and the tangential second sections 13B and slot 11 are arranged so that when the traveller 1 passes along the tubular section 12 the tangential section 13B will pass through the slot 11 so that the traveller 1 can traverse the support 2.

The operation of the invention to allow the traveller 1 to move along a safety line 3 traversing the support 2 when the traveller 1 is in the substantially vertical orientation shown in FIG. 1A is easily understood. The traveller 1 moves along the safety line 3 pulled by the load applied to the engagement section 7 by the user through the safety lanyard until the leading wheel 4 of the traveller 1 contacts the end of the cylindrical tube 12 of the support 2. The wheels 4 then move in turn from the safety line 3 onto the cylindrical tube 12 and the traveller 1 continues to move with the wheels 4 rolling along the top of the cylindrical tube 12. As this movement continues the slot 11 of the traveller 1 moves over the tangential section 13B of the arm 13 of the support 2 so the traveller 1 passes over the support 2. The traveller 1 then continues to move until the wheels 4 move off the end of the tubular section 12 and back onto the safety line 3 on the other side of the support 2.

In order to be sure that the movement of the traveller 1 on, past and off the support 2 is executed smoothly, the ends of the tubular section 12 are tapered so that the wheels 4 of the traveller 1 are presented with a ramp rather than a step as they contact the end of the tubular section 12.

The slot 11 of the traveller 1 is defined between an inner gate 11A formed by an inwardly projecting section of the second side plate 6 and an outer gate 11B formed by an outwardly projecting section of the second side plate 6. The inner gate 11A and the outer gate 11B having opposed convex curved surfaces defining the slot 11 between them. The inner and outer gates 11A and 11B are formed by the side plate 6 on each side of the slot 11 being bent inwardly and outwardly respectively to form a pair of inward and outward projections which extend approximately parallel to one another defining the slot 11 between them.

The geometry of the inner and outer gates 11A and 11B of the slot 11 is that they arranged so that when the traveller 1 is supported on the cylindrical tube 12 the inner and outer gates 11A and 11B lie along a common radius on respective concentric cylindrical surfaces about the centre of rotation of the cylindrical tube 12, which corresponds to the centre of safety line 3.

Further, the tangential section 13B of the arm 13 of the support 2 is a substantially flat plate arranged relative to the cylindrical tube 12 such that when the traveller 1 is supported on the cylindrical tube 12 the part of the tangential section 13B located in the slot 11 between the inner and outer gates 11A and 11B is substantially tangential to a cylindrical surface coaxial with the cylindrical tube 12. Thus, the inner gate 11A and outer gate 11B lie on a common radius of respective coaxial cylindrical surfaces of different sizes and the flat tangential section 13B is tangential to a cylindrical surface coaxial with and having a radius intermediate those of these two cylindrical surfaces.

This geometrical arrangement of the inner and outer gates 11A and 11B of the slot 11 and the tangential section 13B between them lying on coaxial cylindrical surfaces allows a small clearance between the inner and outer gates 11A and 11B and the aim section 13B to accommodate a large range of angular movement of the traveller 1 relative to the support 2, as illustrated in FIGS. 1B and 1C.

It will be understood that for geometrical reasons, because the arm section 13B is formed by a substantially flat plate it can only be tangential to a cylindrical surface coaxial with the cylindrical surfaces on which the inner and outer gates 11A and 11B lie where it passes between the inner and outer gates 11A and 11B for one specific rotational position of the traveller 1 about the cylindrical tube 12 and safety line 3 relative to the support 2. However, as the angular orientation of the traveller 1 relative to the support 2 changes away from this position the linear movement of the planar tangential section 13B relative to the inner and outer gates 11A and 11B from the tangential position is small so that a relatively large degree of angular movement is possible.

For example, when the described embodiment was used in a height safety system with the safety line 3 formed by an eight millimetre diameter steel cable, the width of the slot 11 between the inner and outer gates 11A and 11B was 5 millimetres and the arm 13 of the support 2 was formed from a 3 millimetre thick plate, the traveller 1 was able to travel on the safety line 3 and traverse the support 2 at various positions up to 40° each side of the central position. In use, it is preferred to limit this system to situations where movement of the user is limited to a maximum of 35° each side of the safety line, in order to provide a margin of error.

In the Figures, the central position is shown in FIG. 1A where the traveller 1 is substantially vertical and the extremes of the range of angular movement possible are shown in FIGS. 1B and 1C. It can be seen in FIGS. 1B and 1C that further angular movement of the traveller 1 relative to the support 2 is not possible because one of the inner gate 11A and outer gate 11B will contact the arm 13.

As shown in the Figures, the traveller 1 and support 2 are arranged so that the angular movement of the traveller 1 about the cylindrical tube 12 relative to the support 2 is limited in a first direction, shown in FIG. 1B, by contact of the inner gate 11A of the slot 11 with the radial section 13A of the support 3. The traveller 1 and support 2 are arranged so that at this limiting position of angular movement the part of the second side plate 6 extending between the slot 11 and the wheels 4 is substantially parallel to and slightly separated from the arm section 13B.

At the opposite limit of the angular movement of the traveller 1 relative to the support 2, shown in FIG. 1C, the angular movement is limited by contact of the outer gate 11B with the tangential section 13B. The first side plate 6 and the attachment section 9 are arranged so that they are spaced from the radial section 13A and tangential section 13B of the support 2 in this position. In the illustrated embodiment the first side plate 5 is bulged outwardly in the part extending between the wheels 4 and the attachment section 9 defining the passage 10 in order to maintain a separation between the first side plate 5 and the arm sections 13A and 13B. This bulged arrangement of the first side plate 5 is not essential but allows the maximum range of angular movement to be limited only by the contact of the outer gate 11B with the tangential section 13B.

It should be understood that in this context references to the degree of angular movement allowed between the traveller 1 and the support 2 refers to the degree of angular movement which will allow the traveller to traverse the support 2 as the traveller 1 moves along the safety line 3.

As explained above the slot 11 is narrower than the safety line 3. Further, the cylindrical tube 12 of the support 2 through which the safety line 3 passes must be larger than the safety line 3. Accordingly, the traveller 1 can move along the safety line 3 and the traverse support 2 without any possibility of the traveller 1 becoming released from the safety line 3 or the support 2.

In the description the arm 13 is described as having a radially extending section 13A, vertical in the described embodiment, linked to a tangential section 13B which extends tangentially between the inner and outer gates 11A and 11B of the traveller 1. In practice it is preferable for the radial extent of the radial section 13A, and thus the radius of the notional cylindrical surface coaxial with the cylindrical tube 12 to which the tangential section 13B is tangential, to be as low as possible in order to minimise the bending loads applied to the arm 13 when a fall arrest situation occurs. In such a fall arrest situation, the fall arrest load will be transmitted along the safety line 3 to one or more supports 2, or when a fall arrest event occurs when the traveller 1 is located on a support 2 the fall arrest will be transmitted directly to the support 2. These fall arrest loads are transmitted through the cylindrical tube 12 and through the arm 13 and connection section 14 to the fixed support structure. The greater the radial extent of the radial section 13A and the resulting separation between the tangential section 13B and the tangential tube 12, the greater the bending movement which will be applied to the support arm 13 between the sections 13A and 13B by the fall arrest loads.

Accordingly, in order to minimise this bending movement and prevent deformation of the support 2 this radial extent should be as low as possible.

In the illustrated embodiments the sections 13A and 13B of the arm 13 are connected by a curved joint section. This is convenient to allow the support to be easily manufactured and in particular to allow the arm 13 to be formed from a single plate by a bending operation. The radius of this curved joint or junction between the arm sections 13A and 13B is as required for convenient manufacture and does not have any defined relationship with the radius of the cylindrical surfaces used to define the inner and outer gates 11A and 11B and the arm section 13B. In particular, the curved joint of the arm 13 which forms a junction between the arm sections 13A and 13B is not coaxial with the cylindrical tube 12 of the safety line 3.

As explained above, it is desirable for the radial extent of the radial arm section 13A to be as small as possible. As a result of this and the desire to form the junction between the radial section 13A and the tangential arm section 13B as a radiused curve for ease of manufacture, the radially extending radial section 13A in the illustrated embodiment is flat and extending purely radially only for very short distance from the cylindrical tube 12 before it begins curving to join to the arm section 13B. In general, it is not essential that the radial section 13A has any purely radial section at all. It is essential only that the shape of the radial section 13A is geometrically arranged to have a radially extending component so that the tangential section 13B can be spaced from the cylindrical tube 12 and extend substantially tangentially where it passes between the inner and outer gates 11A and 11B of the slot 11.

As can be seen in the Figures, a radial separation between the tangential section 13B and the cylindrical tube 12 is required in the embodiment in order to accommodate the movement of the inner gate 11A.

The wheels 4 of the traveller 1 are preferably pulleys having a concave rim so that the weight of the traveller 1 and any vertical load applied to the traveller 1 through the safety lanyard tends to locate the traveller 1 with the wheels 4 only in contact with the safety line 3 and/or the central tube 12 of the support 2. This ensures smooth operation of the system by preventing rubbing friction between the safety line 3 and the cylindrical tube 12 of the support 2 and the inner surfaces of the first and second side plates 5 and 6.

In the illustrated embodiment the tangential section 13B of the support 2 is substantially flat. This is not essential. However, the use of a substantially flat plate to form the tangential section 13B allows the tangential section 13B to be easily stiffened by the use of ribs 13D as shown in FIG. 3. This allows a thin tangential section 13B to support fall arrest loads without significant permanent deformation.

Preferably, the arm 13 and the retaining section 14 of the support 2 are formed from a single plate by bending operations.

As explained above, use of the present invention allows the traveller 1 to move along the safety line 3 and traverse the support 2 over a substantial range of angular orientations of the traveller 1 relative to the supports 2 about the safety line 3. However, in order for the slot 11 of the traveller 1 to pass smoothly over the tangential section 13B of the support 2 it is necessary for the traveller 1 to be correctly vertically and longitudinally oriented relative to the support 2.

There are a number of preferred features of the traveller 1 to maintain the traveller 1 in the proper orientation to traverse the support 2.

The use of two wheels 4 in tandem helps to ensure that the traveller 1 is correctly oriented and located relative to the support 2.

Preferably, the cylindrical tube 12 of the support 2 extends sufficiently far along the safety line 3 that both of the wheels 4 of the support 1 are located on the cylindrical tube 12 before the tangential arm section 13B passes into the slot 11. This support of the traveller 1 on the substantially rigid cylindrical tube 12 forming a part of the support 2 provides a more precise orientation and alignment of the traveller 1 than if the traveller 1 was supported on the flexible safety line 3. Further, any misalignment which could be caused by jerking or jumping of the traveller 1 as the wheels 4 contact the end of the cylindrical tube 12 and move from the safety line 3 onto the cylindrical tube 12 will occur before the tangential arm section 13B enters the slot 11.

Further, the inner and outer gates 11A and 11B are shaped to provide a taper at each end of the slot 11. This taper provides a tapered entry into the slot 11 allowing minor misalignment of the traveller 1 relative to the support 2 to be accommodated without the traveller 1 becoming jammed against the support 2 and movement of the traveller 1 being stopped. A taper of 10° as shown in the specific embodiment is preferred, but other values of taper may be used.

The traveller 1 is intended to be able to travel along the safety line 3 and traverse supports 2 in either direction and accordingly the traveller 1 is longitudinally symmetrical. However, it will be understood that the traveller 1 is handed because only one of the side plates 5 and 6 is broken by a slot 11 and accordingly, the traveller 1 can only traverse supports 2 on one side of a safety line 3.

It is preferred that the wheels 4 should be separated by a significant distance so that when the traveller 1 is pulled along the safety line 3 using a safety lanyard connected to the engagement section 7, the tendency for the leading end of the support 2 to lift up is minimised. Such lift up could otherwise prevent the arm section 13B passing through the slot 11 or even bring the connecting section 9 into contact with the safety line 3 causing excessive wear.

Further, it is preferred that the bottom 8A of each of the apertures 8 forming the engagement section 7 should have a substantially flat horizontal central section allowing movement of the carabineer attaching the safety lanyard relative to the traveller 1 in a longitudinal direction parallel to the safety line 3.

This feature shown in FIG. 5, in which a carabineer ring 15 formed at one end of a safety lanyard (not shown) passes through the openings 8 and around the engagement section 7. When the traveller 1 is mounted on the safety line 3 the carabineer ring 15 will remain at the bottom of the aperture 8 under its own weight and the weight of the safety lanyard. When the user moves so that a load is applied along the safety lanyard through the carabineer ring 15 to the traveller 1 pulling it along the safety line 3, the carabineer ring 15 will tend to move across the substantially flat central portions of the bottoms 8A of the apertures 8 in the direction in which the traveller 1 is being pulled. This ensures that the load applied to the traveller 1 by the safety lanyard through the carabineer ring 15 will be applied ahead of the centre of the traveller 1 relative to the direction in which the traveller 1 is being pulled. This arrangement of the load applied to the traveller 1 to the safety lanyard is applied towards the front of the traveller 1 as it is moving to prevent lifting up of the front of the traveller 1 when pulled. In theory, the ideal geometrical arrangement would be for the engagement section 7 to be extended along the length of the traveller 1 so that the point of contact of the carabineer ring 15 with the sides of the apertures 8 was vertically below the axis of rotation of the leading wheel 4. However, this arrangement will result in the traveller 1 as a whole being rather large and cumbersome so it is normally preferred for the range of movement of the connection to the safety lanyard relative to the engagement section 7 to be smaller than this.

In order to have the movement of the traveller 1 on the safety line 3 be as stable as possible it is preferred for the axes of rotation of the two wheels 4 to be symmetrically arranged on each side of the lower surface 8A of the apertures 8 which is contacted by the connector to the safety lanyard. That is, the lower surface 8A should lie on the longitudinal centre line of the traveller 1 and the wheels 4 should be arranged symmetrically about this centre line.

One possible weak point of the traveller 1 is that the passage 10 through which the safety line 3 passes is broken by the slot 11 which could allow the safety line 3 to pass through if sufficient load were applied. The inner and outer gates 11A and 11B are arranged so that the traveller 1 cannot become suspended from the safety line 3 with the safety line 3 resting against the slot 11. This is ensured by the inner gate 11A having an inward lower face 11C which is inclined at an angle to the vertical when the traveller 1 is vertical. Further, the face 11C has its lowest point, the corner where it contacts the outer face of the inner gate 11A facing the outer gate 11B, located relative to the inner face of the outer gate 11B such that if the safety line 3 is against the slot 11 in contact with the inner and outer gates 11A and 11B the centre of the safety line 3 will lie inwards, towards the passage 10, relative to the lowest point of the face 11C. That is, the centre of the safety line 3 will lie between the lowest point of the face 11C and the lateral centre of the traveller 1.

If a load is applied to the traveller 1 through the safety lanyard the traveller 1 will tend to rotate about the safety line 3 so that the traveller 1 is in line with the applied force. As a result, when a load is applied to the traveller 1 through the safety lanyard when the safety line 3 is located against the slot 11, this will cause rotation of the traveller 1 about the safety line 3 which will move the traveller 1 into an orientation where the applied load will cause the inclined face 11C of the inner gate 11A to slide across the surface of the safety line 3 such that the safety line 3 and traveller 1 will release from the position where the safety line 3 is held against the slot 11 to a position where the safety line 3 is held against the wheels 4. This ensures that in a fall arrest situation the loads applied to the traveller 1 along the safety lanyard cannot be applied in a direction which will tend to pull the safety line 3 through the slot 11.

The first and second side plates 5 and 6 are rigidly connected together by a connecting piece (not visible in the Figures) located between the two wheels 4. If such a rigid connection was not provided, any play in the bearings connecting the wheels 4 to the first and second side plates 5 and 6 would result in relative movement of the inner and outer gates 11A and 11B opening and closing the slot 11.

It is preferred that the bearings connecting the wheels 4 to the first and second side plates 5 and 6 should be strong enough to remain in place under any load expected to be applied to the traveller 1 in a fall arrest situation. However, because of the connecting piece linking the first and second side plates 5 and 6, even if the bearings fail and the wheels 4 separate from the traveller 1 the traveller 1 will not become detached from the safety line 3 or support 2.

The embodiment illustrated in the Figures is intended for use a height safety system where the safety line 3 is located over the area in which the user will travel and work. The large range of angles at which the traveller 1 will pass over the support 2 as it moves along the safety line 3 will allow the user to move and work in a relatively large area below and to both sides of the safety line 3, the extent of this area depending upon the height at which the safety line 3 is located.

In such a system where the traveller 1 is above and at some distance from the user it may be difficult for the user to tell whether or not the wheels 4 are rotating as the traveller 1 moves along the safety line 3. As a result, if the wheels 4 become jammed this may not be apparent to the user, making the system less effective and reliable.

In order to avoid this problem, the wheels 4 project outside the side plates 5 and 6 and the wheels 4 have slots 4A passing through them so that the slots 4A are visible as the wheels 4 rotate. The slots 4A provide a clear visual indication to the user at a distance as to whether the wheels 4 are properly rotating.

In the embodiment the traveller 1 is intended for use in a height safety system where the user works in an area below and on both sides of the safety line 3. Accordingly, the system is arranged so that the centre of the travellers range of movement is vertical with a substantially equal range of movement being possible to each side.

If the height safety system is intended to be used in other arrangements the range of movement of the user could be arranged to be centred about some other angle if desired. For example, if the system were to be used in a situation where the safety line is mounted on a wall and a user will move and work in an area extending away from the wall so that the user will be directly below or to one side only of the safety line, the traveller and support could be arranged so that one limit of the travellers range of movement was substantially vertical, corresponding to the user being substantially against the wall and below the safety line, with the centre and other extreme of the movement being displaced from the vertical accordingly.

In a system otherwise similar to the described example this would provide a range of movement from vertical to 80° from the vertical to one side only of the safety line with the central position corresponding to that shown in FIG. 1A lying at an angle of 40° to the vertical.

The requirements for such differently oriented systems can easily be understood by analogy to the described embodiments. In such differently oriented systems the necessary radial separation of the arm section of the support passing though the slot of the traveller will be in some direction other than the vertical.

Use of wheels 4 in the traveller 1 is preferred to allow smooth travel along the safety line 3 and across the support 2 without requiring the user to apply a large force along the safety lanyard. However, the use of wheels is not essential.

A second embodiment is shown in FIGS. 6A and 6B which does not use wheels.

In the second embodiment of the invention the traveller 21 is formed by a single curved cylindrical plate 22 formed in a curve extending around the safety line 3 to form a generally cylindrical tube broken by a slot 23 formed between an inner gate 22A formed by an inwardly projecting end of the plate 22 and an outer gate 22B formed by an outwardly projecting end of the plate 22.

The geometry of the inner and outer gates 22A and 22B and the slot 23 is the same as the geometry of the inner and outer gates 11A and 11B and slot 11 of the first embodiment so that the traveller 21 can move along a safety line 3 and traverse supports 2 without releasing the safety line 3.

The traveller 21 includes an attachment section 22C formed by an outwardly projecting section of the plate 22 with an aperture 24 allowing a carabineer or similar attachment device to be secured to the traveller 21 bypassing though the aperture 24.

Preferably the plate is divided into three sections along its length, the end sections extending around the safety line 3 to form the outer gate 22B and the central section extending radially from the safety line 3 to form the attachment section 22C.

In use the traveller 21 operates similarly to the traveller 1 as explained above.

In the first embodiment the first side plate 5 is curved round to provide a part of the securing section 9 and has ribs 16 to increase its rigidity in order to prevent the first side plate 5 bending under load and allowing the slot 11 to open out. In this embodiment, the first side plate 5 and part of the securing section 9 are formed from a single plate and the engagement section 7 and the part of the second side plate 6 including the outer gate 11B are formed from a second single plate by bending and the remainder of the second side plate 6 including the inner gate 11A is formed from a third plate. This is a preferred construction in order to allow the traveller 1 to be formed with the necessary geometry and strength while minimising its weight and expense, but other constructions are possible.

A third embodiment is shown in FIGS. 7A and 7B. These show the traveller 31 formed by a single plate 32 supporting a pair of wheels 33 arranged in tandem.

In the third embodiment the wheels 33 are formed so that their rims define the channel receiving the safety line 3 and the outer rim 33A of the wheel 33 projects inwardly to form the inner gate 11A. An end of the plate 22 is bent around the safety line 3 to form the outer gate 32B so that the rims 33A of the wheels 33 and the outer gate 32B formed by the plate 32 define a slot 34 between them.

The inner and outer gates 33A and 32B and the slot 34 are arranged similarly to the inner and outer gates 11A and 11B and slot 11 of the first embodiment so that the traveller 31 can move along the safety line 3 and pass over the support 2 without releasing the safety line 3 from the traveller 31.

A downwardly projecting section of the plate 32 extends radially from the safety line 3 to form an attachment element 32C having an aperture 35 allowing a safety lanyard to be attached to the traveller 31 using a carabineer or similar attachment device passing through the aperture 35.

Similarly to the first and second embodiment the plate 32 is arranged to have two end sections adjacent the wheels 33 and extending around the safety line 3 to form the outer gates 32B and a central section extending radially to the safety line 3 to form the attachment section 32C.

In the above embodiment the safety line 3 and/or support 2 are retained within a passage defined by rigid components of the traveller so that the traveller can only be removed from the safety line 3 by passing the traveller over the end of the safety line 3 or by providing special supports 2 incorporating an openable section. Such openable arrangements allowing travellers to be removed and detached from safety lines are well known in the art.

If desired a lockable opening mechanism could be incorporated into the traveller to allow the traveller to be attached to and removed from the safety line at any point. Such lockable opening devices are well known in the art.

A fourth embodiment of the invention is shown in FIGS. 8A to 8E.

The traveller 41 of the fourth embodiment includes a pair of rollers 42 each having an outer rim forming the inner gate 42A similarly to the rollers 33 of the third embodiment. Further, the traveller 41 includes a further pair of rollers 43 having outer rims which define an outer gate 43B. Respective opposed ones of the first rollers 42 and second rollers 43 are arranged to rotate about parallel axes so that their outer rims forming the inner gate 42A and outer gate 43B define a slot 44 between them.

The inner gate 42A, outer gate 34B and slot 44 are arranged similarly to the inner gate 11A, outer gate 11B and slot 11 according to the first embodiment to allow the traveller 41 to move along the safety line 3 and traverse supports 2 without being released from the safety line 3.

Further, the traveller 41 has a downwardly extending section forming an attachment element 45 with an aperture 46 allowing a safety lanyard to be attached to the traveller by passing a carabineer or similar attachment device through the aperture 46.

Preferably, the rollers 42 and 43 are pivotally connected for relative movement about an axis 47 between a first retaining position and a second releasing position. The traveller 41 is shown in the first retaining position in FIGS. 8A to 8D and in the second releasing position in FIG. 8E.

In the first retaining position the axes of rotation of the rollers 42 and 43 are parallel and the slot 44 is narrower than the diameter of the safety line 3 so that the traveller 41 cannot be released from the safety line 3.

In the second releasing position the slot 44 is widened so that the safety line 3 can pass through it. Accordingly, when the traveller 41 is in the second releasing position the traveller can be moved from or attached to a safety line 3.

The attachment element 45 is formed by two parallel extensions with respective apertures 46. A first one of the extensions is rigidly attached to the first pair of rollers 42 while the second section is rigidly attached to the second pair of rollers 43. The apertures 46 are arranged so that they are in line allowing a carabineer or other safety harness to be inserted only when the traveller is in the first retaining position. Further, the apertures 46 are sized so that when a carabineer or similar safety device is located passing though both of the apertures 46 it is not possible to move the rollers 42 and 43 from the first retaining position to the second releasing position. This arrangement of interlocking prevents accidental release of the traveller 41 from the safety line 3 while in use.

The use of pairs of opposed rollers to define the inner gate, outer gate and slot according to the fourth embodiment does not require the use of a lockable opening mechanism to release the traveller from the safety line. The roller arrangement according to the fourth embodiment could be used with a rigid traveller arrangement if desired.

The person skilled in the art will be able to envisage numerous modifications or substitutions of mechanical equivalents in the described embodiments and such modifications and substitutions are part of the present invention.

1. A traveller for a fall arrest system comprising:
a body having a passage therethrough, a slot narrower than the passage linking the passage to the exterior of the body, and a load member suitable to attach the traveller to fall safety equipment, the slot being formed between an inner gate extending outwardly relative to the passage and an outer gate extending inwardly relative to the passage, the inner gate and outer gate having respective opposed convex surfaces defining the slot between them, the traveller being arranged such that when the traveller is mounted on a support the inner gate and outer gate lie on a common radius of respective concentric circles about the support.

2. A support for a safety line in a fall arrest system comprising a support section suitable for retaining a safety line and attachment means for attaching the support to a structure, the supporting section and the attachment means being connected by an arm, the arm having a tangential section narrower than the safety line and extending substantially tangentially relative to a safety line retained in the supporting section.

3. A fall arrest system comprising a safety line, at least one support and a traveller, in which the support comprises a support section retaining the safety line and an attachment means for attaching the support to a structure, the support section and attachment means being connected by an arm having a tangential section narrower than the safety line and extending substantially tangentially relative to the safety line, and the traveller comprising a body having a passage therethrough, a slot narrower than the safety line linking the passage to the exterior of the body and a load member suitable to attach the traveller to fall safety equipment, the slot being formed between an inner gate and an outer gate having respective opposed surfaces defiming the slot between them, the inner gate and outer gate being arranged such that when the traveller is mounted on the support within the passage the tangential section of the arm can pass through the slot.

4. A fall arrest system as claimed in claim 3, in which the inner gate extends outwardly relative to the passage, the outer gate extends inwardly relative to the passage, and the slot is defined between convex opposed surfaces of the inner and outer gates.

5. A fail arrest system as claimed in claim 3, in which the traveller is arranged so that when the traveller is mounted on the support the inner gate and outer gate lie on a common radius of respective concentric circles about the safety line.

6. Apparatus according to claim 2, in which the support section is a cylindrical tube.

7. Apparatus according to claim 2, in which the tangential section is spaced from the support section.

8. Apparatus according to claim 2, in which the tangential section is a fiat plate.

9. Apparatus according to claim 2, in which the tangential section and the support section are connected by a linking section, the linking section extending in a direction having a radial component relative to said safety line.

10. Apparatus according to claim 9, in which file attachment means, tangential section and support section are integrally formed from a single plate.

11. Apparatus according to claim 1, in which the traveller has two wheels arranged in tandem so that the traveller can be mounted on the wheels on a safety line passing through the passage.

12. Apparatus according to claim 11, in which the load member is located below and between said wheels when the traveller is mounted on the wheels on a safety line.

13. Apparatus according to claim 12, in which the load member is a closed aperture passing through the body.

14. Apparatus according to claim 13, in which the wheels are arranged for rotation about respective parallel axes, and the aperture has a flat lower surface extending parallel to a plane in which said axes lie.

15. Apparatus according to claim 14, in which said axes are symmetrically arranged about a longitudinal centre line of the traveller and said lower surface lies on said centre line.

16-18. (canceled)
